(19) United States
(12) Patent Application Publication
(10) Pub. No.: US 2024/0354873 A1
(43) Pub. Date: Oct. 24, 2024

(54) INITIAL ALLOCATION OPTIMIZATION METHOD OF WATER RIGHTS BASED ON REGRET THEORY

(71) Applicant: Zhejiang Institute of Hydraulics & Estuary, Hangzhou (CN)

(72) Inventors: Caijie YANG, Hangzhou (CN); Chenkai CAI, Hangzhou (CN); Helong WANG, Hangzhou (CN); Jinhua WEN, Hangzhou (CN); Qifeng LI, Hangzhou (CN)

(21) Appl. No.: 18/627,637

(22) Filed: Apr. 5, 2024

(30) Foreign Application Priority Data
Apr. 18, 2023 (CN) 202310428934.4

(51) Int. Cl. G06Q 50/06; G06Q 10/04

(52) U.S. Cl. CPC G06Q 50/06; G06Q 10/04

(57) ABSTRACT

The disclosure relates to a water resource planning method. An objective is to provide an initial allocation optimization method of water rights based on regret theory. A technical scheme is as follows: the initial allocation optimization method of water rights based on regret theory includes following steps: S1, basic data set preparation: collecting relevant data of regional society, economy, water conservancy and agriculture; S2, objective function setting: considering economic, social and ecological values of water resources utilization, determining three objective functions of maximum social benefit, maximum economic benefit and maximum ecological benefit; S3, constraint condition setting: a supply and demand balance constraint of a water resource and a water demand constraint of a water use department; S4, multi-objective optimization algorithm: using a second generation non-dominated sorting genetic algorithm (NSGA-II) as the multi-objective optimization algorithm; and S5, initial allocation scheme of water rights based on regret theory.

### CROSS-REFERENCE TO RELATED APPLICATIONS

This application claims priority to Chinese Patent Application No. 202310428934.4, filed on Apr. 18, 2023, the contents of which are hereby incorporated by reference.

### TECHNICAL FIELD

The disclosure relates to a water resources planning method, in particular to an initial allocation optimization method of water rights based on regret theory.

### BACKGROUND

Water is an indispensable natural resource for human life and production. With the socio-economic development and population growth, the global water demand is increasing year by year. Limited water resources and increasing water demand will inevitably lead to water conflicts among water use departments. It is an urgent problem to be solved in China's current water resources planning and management that how to alleviate water conflicts and realize efficient use of limited water resources through reasonable water resources allocation.

The initial allocation of water rights may be regarded as an optimization problem involving multiple objectives and complex constraints. At present, scholars at home and abroad have put forward a series of optimization objectives for the initial allocation of water rights, including maximum economic benefits, maximum social benefits, maximum environmental benefits, minimum water shortage in a system, and highest social happiness. Multi-objective decision-making methods, such as analytic hierarchy process, weight method and projection pursuit method, have also been applied to the initial allocation of water rights. Traditionally, multi-objective decision-making problems are usually solved by transforming multi-objectives into single objectives through prior knowledge (such as experience and expert opinions). This method may only provide a unique “optimal” scheme for decision makers, and it is highly dependent on an accuracy of prior knowledge. With the improvement of computer computing power and the development of intelligent optimization algorithm, multi-objective Pareto Frontier is directly solved by intelligent optimization algorithm, and various schemes on Pareto Frontier are sorted to determine a best scheme, which has been widely used in many fields such as economy, transportation, water conservancy and so on. However, although a current intelligent algorithm has been greatly improved in optimization ability and speed, it is almost impossible to find Pareto frontier completely in a complex multi-objective high-dimensional space. Therefore, compared with an absolute rational decision-making method that pursues an only optimal solution, the initial optimization allocation of water rights is closer to a bounded rational decision-making problem, that is, the decision maker is not pursuing a theoretical optimal scheme, but seeking a satisfactory scheme that may be accepted by all parties.

Therefore, it is necessary to formulate reasonable distribution objectives and constraints according to natural, economic and social attributes of water rights. Based on a bounded rational decision-making theory and a multi-objective optimization algorithm, an optimization model of initial allocation of water rights is established to provide a technical support for the initial allocation of water rights in regions and industries.

### SUMMARY

An objective of the disclosure is to overcome shortcomings of the above background technology and provide an initial allocation optimization method of water rights based on regret theory, so as to realize initial allocation of water rights by regions and industries, improve a management capacity of water resources, and improve a utilization efficiency of the water resources while ensuring fairness.

A technical scheme provided by the disclosure is as follows.

The initial allocation optimization method of water rights based on regret theory includes following steps.

### S1. Basic Data Set Preparation

Relevant data of regional society, economy, water conservancy and agriculture are collected, including information on regional total available water supply, predicted water demand for water resources planning, water consumption per 10,000 CNY of industrial added value, agricultural production increased benefit after irrigation and water conservancy allocation coefficient.

### S2. Objective Function Setting

In an initial allocation optimization problem of water rights, decision variables are water supplies allocated by different water sources to different regions and different water use departments. Considering economic, social and ecological values of water resources utilization, the disclosure determines three objective functions of maximum social benefit, maximum economic benefit and maximum ecological benefit.

### (1) Objective Function of Maximum Social Benefit

In the disclosure, a maximum social benefit goal max f₁ is expressed by a degree of coordination between supply and demand, which may be calculated by a sum of differences between water demands and water supplies of all water use departments in all regions. A specific calculation formula is as follows:

$$max {f}_{1} = {\sum }_{i = 1}^{I} {\sum }_{j = 1}^{J} ( {\sum }_{k = 1}^{K} {x}_{j , k}^{i} - {d}_{j}^{i} ) {α}_{j} , \qquad ( 1 )$$

where dⱼⁱ is a water demand of a j-th water use department in an i-th region; x_{j,k}ⁱ is a water supply (i.e. decision variable) for a k-th water source to the j-th water use department in the i-th region; I, J and K are a total number of regions, a total number of water use departments and a total number of water sources respectively; αⱼ is a water supply order coefficient, that is, a water use order of the j-th water use department, which may be calculated by a formula 2:

$${α}_{j} = \frac{1 + {n}_{max} - {n}_{j}}{{\sum }_{j = 1}^{J} {n}_{j}} , \qquad ( 2 )$$

where, nⱼ is a water use order; nₘₐₓ is a maximum value of the water use order.

### (2) Objective Function of Maximum Economic Benefit

In the disclosure, a water supply benefit max f₂ considering the water supply order is taken as a maximum economic benefit goal of initial allocation of water rights, and a specific calculation formula is as follows:

$$max {f}_{2} = {\sum }_{i = 1}^{I} {\sum }_{j = 1}^{J} {\sum }_{k = 1}^{K} ( {b}_{j}^{i} - {c}_{j , k}^{i} ) {x}_{j , k}^{i} {α}_{j} , \qquad ( 3 )$$

where bⱼⁱ is a water supply benefit coefficient of the j-th water use department in the i-th region; and c_{j,k}ⁱ is a cost coefficient of supplying water for the k-th water source to the j-th water use department in the i-th region.

### (3) Objective Function of Maximum Ecological Benefit

In the disclosure, an ecological guarantee rate max f₃ is adopted as a maximum ecological benefit goal, and a specific calculation formula is as follows:

$$max {f}_{3} = - {\sum }_{i = 1}^{I} {\sum }_{j = 1}^{J} \frac{{\sum }_{k = 1}^{K} {x}_{j , k}^{i}}{{P}_{j}^{i}} , \qquad ( 4 )$$

where Pⱼⁱ is an ecological water demand of the j-th water use department in the i-th region.

### S3. Constraint Condition Setting

Constraint conditions of the disclosure include a supply and demand balance constraint of a water resource and a water demand constraint of a water use department:

### (1) The Supply and Demand Balance Constraint of the Water Resource

$${\sum }_{i = 1}^{I} {\sum }_{j = 1}^{J} {\sum }_{k = 1}^{K} {x}_{j , k}^{i} \leq {\sum }_{k = 1}^{K} {W}_{k} , \qquad ( 5 )$$

where Wₖ is an available water supply of the k-th water source.

### (2) The Water Demand Constraint of the Water Use Department

$${Q}_{min , j}^{i} \leq {d}_{j}^{i} \leq {Q}_{max , j}^{i} , \qquad ( 6 )$$

where Q_{min,j}ⁱ and Q_{max,j}ⁱ are a minimum water demand and a maximum water demand of a j-th water user in the i-th region, respectively.

### S4. Multi-Objective Optimization Algorithm

According to the disclosure, a second generation non-dominated sorting genetic (NSGA-II) algorithm is adopted as the multi-objective optimization algorithm (prior art). The initial allocation problem of water rights is optimized based on the objective functions and constraint conditions, so as to obtain an optimal allocation amount of each water source to different regions and industries.

Steps of initial optimization allocation of water rights by the NSGA-II algorithm are as follows:
step 1: randomly initializing a parent population P₀ with a scale of n, ranking all individuals according to a non-dominant relationship and specifying a fitness value, and using selection, crossover and mutation operators to generate a next generation population Q₀ with a scale of n, and letting t=1;
step 2: judging whether a termination condition has been reached or whether evolutionary algebra t has reached a maximum; if the termination condition has been reached or the evolutionary algebra t has reached the maximum, terminating an evolution and outputting a current quasi-Pareto frontier; if the termination condition has not been reached or the evolutionary algebra t has not reached the maximum, continuing;
step 3: merging a parent Pₜ and a child Qₜ into a population Rₜ with 2n individuals;
step 4: performing non-dominated sorting and congestion comparison on the population Rₜ after the merging to generate a new population Pan with a scale of n;
step 5: for a new generation population, repeating a next round of selection, crossover and mutation to obtain a new child Qₜ₊₁; and
step 6: when the evolutionary algebra t=t+1, turning back to the step 2.

### S5. Initial Allocation Schemes of Water Rights Based on Regret Theory

According to Pareto frontiers obtained after optimization in the S4, it is assumed that there are I initial allocation schemes of water rights in the frontiers, and each scheme is described by three attributes, namely social benefit, economic benefit and ecological benefit. At the same time, considering dimensional differences among the three objective functions, a formula 7 is adopted for normalization of the dimensional differences to eliminate an influence of different dimensions on decision-making results.

$${z}_{i}^{k} = \frac{{y}_{i}^{k} - {y}_{i , min}^{k}}{{y}_{i , max}^{k} - {y}_{i , min}^{k}} , \qquad ( 7 )$$

where yᵢ^{k} represents a performance value of a scheme i (i=1, 2, . . . I) on an attribute k (k=1, 2, 3); y_{i,max}^{k} and y_{i,min}^{k} are a maximum value and a minimum value of yᵢ^{k} respectively; zᵢ^{k} represents a performance value of the scheme i (i=1, 2, . . . I) after the normalization on the attribute k (k=1, 2, 3).

From a perspective of the attribute k, regret values generated by selecting the scheme i instead of a scheme j (i≠j) may be quantified by a following formula:

$${R}_{i ↔ j}^{k} = ln ( γ + exp [ {β}_{k} ( {z}_{j}^{\dot{k}} - {z}_{i}^{k} ) ] ) , \qquad ( 8 )$$

where zᵢ^{k} and zⱼ^{k} are performance values after the normalization of the scheme i and the scheme j corresponding to the attribute k, respectively; βₖ is a preference parameter, indicating a contribution of the attribute k to a total regret, and reflecting subjectivity of a decision maker. γ is a regret weight parameter, indicating an intensity of regret.

According to a formula 8, for the scheme i, a regret metric function is:

$${R}_{i} = {\sum }_{j = 1 , j \neq i}^{J} {\sum }_{k = 1}^{3} ln ( γ + exp [ {β}_{k} ( {z}_{j}^{k} - {z}_{i}^{k} ) ] ) , \qquad ( 9 )$$

Through a formula 9, different schemes are compared and selected, and a minimum regret metric function is a best scheme.

The disclosure has beneficial effects of providing an initial allocation optimization method of water rights based on bounded rational decision-making, which is helpful for water resource managers to formulate the initial allocation schemes of water rights, coordinate water consumption of different water use departments as a whole, realize an intensive and safe utilization of the water resources, and better play a supporting role of the water resources for high-quality social and economic development.

### BRIEF DESCRIPTION OF THE DRAWINGS

FIG. 1 is a flow chart of the disclosure.

FIG. 2 is a flowchart of an NSGA-II algorithm in the disclosure.

FIG. 3 is a water supply pattern diagram of city Y in an embodiment of the disclosure.

FIG. 4 is a schematic diagram of results of an NSGA-II algorithm in an embodiment of the disclosure.

### DETAILED DESCRIPTION OF THE EMBODIMENTS

An idea of the disclosure is to provide an initial optimization allocation method of water rights based on bounded rational decision-making, which provides a data basis and a technical support for an initial allocation of water rights and a construction of water rights trading system. First of all, relevant data such as available water supply of water sources and social and economic development in a study area are collected to provide a data basis for multi-objective decision-making. Then, according to objective functions and constraint conditions, Pareto frontiers of an allocation problem of water rights are calculated by an NSGA-II optimization algorithm. Finally, based on a regret theory, a regret metric function of each scheme on the Pareto frontiers is calculated, and a scheme with a minimum regret metric function is selected as a best scheme.

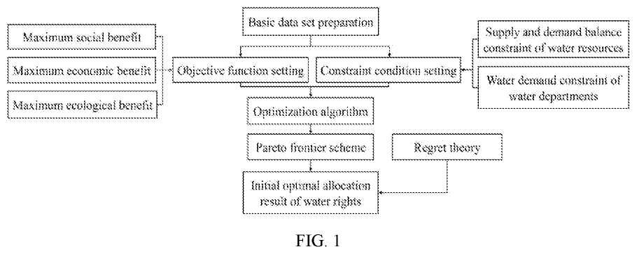

A process of an initial optimization allocation method of water rights based on regret theory is shown in FIG. 1: basic data set preparation, objective function setting, constraint condition setting, multi-objective optimization algorithm (optimization algorithm) and initial allocation scheme of water rights based on regret theory (initial optimization allocation result of water rights) in turn.

The disclosure will be further explained by attached drawings and specific embodiments.

An initial optimization allocation of water rights of different water use departments in Y city, a county-level city in southern China is taken as an example, this method is used for analysis.

### I. Overview of Study Area and Data Set Preparation

Located in the south of China, Y City is an economically developed area with a large resident population, a large demand for water resources and a prominent contradiction between supply and demand of water resources. At present, there are six medium-sized reservoirs, two small (1) reservoirs and two extraterritorial water diversion projects, which mainly supply four departments of life, ecology, industry and agriculture. Required parameters in formulas 1-6 are obtained according to a statistical yearbook of Y city, water resources bulletin and related planning data.

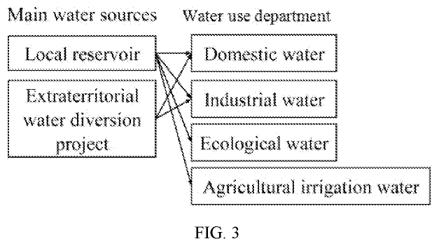

According to the parameters in a formula 1, this embodiment takes 2025 as a horizontal year, and adopts relevant planning results, and water demands d′ of the four departments of life, ecology, industry and agriculture are 145,500,000 m³, 15,000,000 m³, 73,000,000 m³ and 70,000,000 m³ respectively. According to a water supply pattern of Y city (FIG. 3), values of a total number I of regions, a total number J of water use departments and a total number K of water sources in this embodiment are 1, 4 and 2 respectively. Among them, the extraterritorial water diversion projects only supply water to the water use departments of life and industry, and local reservoirs are responsible for supplying water to the four water use departments of life, ecology, industry and agriculture.

According to an actual situation of water supply in Y city, a water supply order in calculation of this embodiment is in the order of ecology, life, industry and agriculture, that is, in a formula 2, a water use order nⱼ in life, ecology, industry and agriculture is 2, 1, 3 and 4 respectively.

According to the parameters in a formula 3, a water supply benefit coefficient of each department bⱼⁱ is calculated as follows: a water consumption per 10,000 CNY of industrial added value in Y city is about 22.2 m³/10,000 CNY, and its reciprocal is taken as an industrial water benefit coefficient of 450 CNY/m³. According to the relevant planning, a benefit coefficient of agricultural irrigation water is determined by multiplying an agricultural production increased benefit after irrigation by a water conservancy allocation coefficient, and its value is 100 CNY/m³. At present, water use benefits of life and ecology have not formed a unified quantitative standard, and there is no clear range of values. Considering their importance to the social economy, this embodiment takes a large value of 1000 CNY/m³ as their benefit coefficient. In this embodiment, water charges of different water use departments are taken as a cost coefficient c_{j,k}ⁱ, which is determined according to a water charge collection standard of Y city. The water charges of different water sources used by different water use departments are the same, but there are differences among the departments. The water charges for life, ecology, industry and agriculture are 2.87 CNY/m³, 0 CNY/m³, 4.27 CNY/m and 0.2 CNY/m³ respectively. For the parameters in a formula 4, considering that there is no ecological water demand in the water use departments of life, industry and agriculture, an ecological water demand of the water use department of ecology is equal to its water demand. Therefore, ecological water demands P′ of the four departments of life, ecology, industry and agriculture are 0 m³, 15,000,000 m³, 0 m³, 0 m³ respectively.

According to the parameters in a formula 5, there are mainly two water sources in the city, namely, water supply reservoirs and the extraterritorial water diversion projects, and the available water supplies Wₖ are 97,620,000 m³/year (95% water supply guarantee rate) and 90,000,000 m³/year respectively.

In a formula 6, minimum water demands Q_{min,j}ⁱ of regional water use departments are all 0 m³, and a maximum water demand Q_{max,j}ⁱ is the water demand of this department, and the water demands of the four departments of life, ecology, industry and agriculture are 145,500,000 m³, 15,000,000 m³, 73,000,000 m³ and 70,000,000 m³ respectively.

### II. Initial Multi-Objective Optimization Allocation of Water Rights

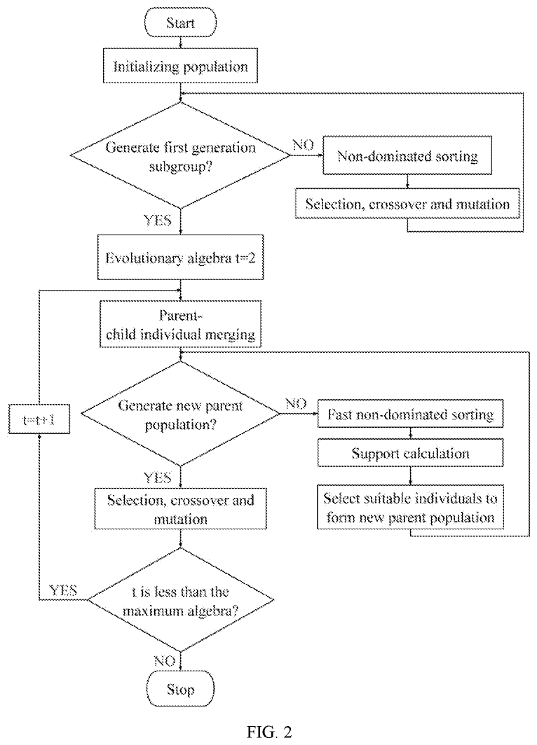

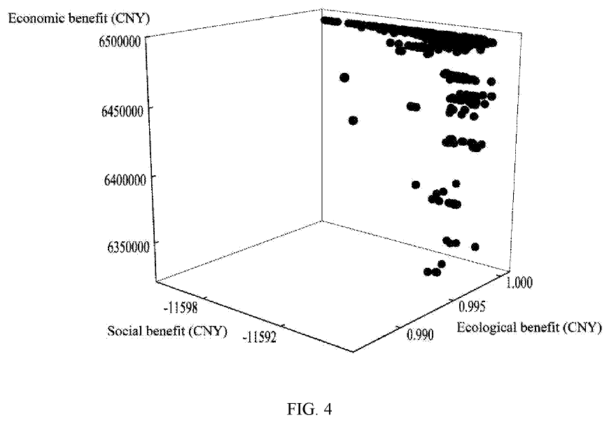

The NSGA-II algorithm is used for multi-objective optimization calculation of a decision variable x_{j,k}ⁱ, and an initial population number is set to 1000, and a maximum iteration step size is 100000, so as to generate Pareto frontier results, which are normalized by maximum and minimum values. The algorithm is calculated based on the steps in FIG. 2. Because there are 1000 non-inferior solutions finally generated, a following table only shows some results of NSGA-II optimization, and detailed Pareto frontier results are shown in FIG. 4 (each point in the figure represents a calculation result).

TABLE 1
Partial optimization results of NSGA-II algorithm

| | | | | | Allocation of | | | | |
|---|---|---|---|---|---|---|---|---|---|
| | | | | | water rights for | | | | |
| | | | | | extraterritorial | | | | |
| | | | | | water diversion | | | | |
| | Allocation of water rights of local | | | | projects | | Social | Economic | Ecological |
| Scheme | reservoirs (10,000 m³) | | | | (10,000 m³) | | benefit | benefit | benefit |
| number | Life | Industry | Agriculture | Ecology | Life | Industry | (CNY) | (CNY) | (CNY) |
| 1 | 6966 | 767 | 532 | 1496 | 7160 | 1840 | −11589.7 | 6325895 | 0.997 |
| 2 | 7266 | 576 | 417 | 1500 | 7228 | 1772 | −11590.7 | 6448710 | 1.000 |
| 3 | 7075 | 762 | 425 | 1499 | 7319 | 1680 | −11590.6 | 6416962 | 0.999 |
| 4 | 6983 | 986 | 297 | 1495 | 7272 | 1728 | −11588.2 | 6382394 | 0.997 |
| 5 | 6983 | 986 | 297 | 1495 | 7272 | 1728 | −11588.2 | 6382394 | 0.997 |
| 6 | 7284 | 481 | 496 | 1500 | 7228 | 1772 | −11589.4 | 6448887 | 1.000 |
| 7 | 7304 | 484 | 480 | 1493 | 7223 | 1777 | −11590.1 | 6452931 | 0.995 |
| 8 | 6961 | 598 | 702 | 1500 | 7572 | 1427 | −11590 | 6441048 | 1.000 |
| 9 | 7078 | 1172 | 17 | 1493 | 7160 | 1840 | −11590.3 | 6395497 | 0.996 |

. . .

### III. Initial Optimization Allocation Results of Water Rights

Normalization is performed by a formula 7, and a regret metric function of each scheme is calculated by a formula 8 and a formula 9 respectively. Values of preference parameters and a regret weight parameter may be set according to a decision maker's own preferences. Among them, a value range of the preference parameters is [0,1], and a sum of the preference parameters is 1. The regret weight parameter reflects a sensitivity of the decision maker to regret values, and a value range is [0,1]. In this embodiment, the preference parameters of the three objective functions (social benefit, economic benefit and ecological benefit) are respectively 0.5, 0.2 and 0.3, and the regret weight parameter is 0.25. Specific calculation results are shown in Table 2, so an optimal scheme is the best scheme.

TABLE 2
Best scheme obtained based on regret theory

| | | | | | Allocation of water | | | | |
|---|---|---|---|---|---|---|---|---|---|
| | | | | | rights for | | | | |
| | | | | | extraterritorial | | | | |
| | Allocation of water rights of local | | | | water diversion | | Social | Economic | Ecological |
| Scheme | reservoirs (10,000 m³) | | | | projects (10,000 m³) | | benefit | benefit | benefit |
| number | Life | Industry | Agriculture | Ecology | Life | Industry | (CNY) | (CNY) | (CNY) |
| 702 | 7230 | 1021 | 11 | 1500 | 7316 | 1684 | −11588.2 | 6492948 | 1.000 |

According to the above results, considering the social, economic and ecological benefits, priorities and water demands of different water use departments, a high-quality water right in Y city should give priority to meeting water demands of life and ecology, and a priority of agricultural water use is low and the economic benefit is poor, and only a small amount of water right is used for an agricultural water supply demand.

What is claimed is:

1. An initial allocation optimization method of water rights based on regret theory, comprising following steps:
S1: basic data set preparation
collecting relevant data of regional society, economy, water conservancy and agriculture, comprising regional total available water supply, predicted water demand for water resources planning, water consumption per 10,000 CNY of industrial added value, agricultural production increased benefit after irrigation and water conservancy allocation coefficient;
S2: objective function setting in an initial allocation optimization problem of water rights, decision variables are water supplies allocated by different water sources to different regions and different water use departments; determining three objective functions of maximum social benefit, maximum economic benefit and maximum ecological benefit;
(1) objective function of maximum social benefit
a maximum social benefit goal max f₁ is a sum of differences between water demands and water supplies of all water use departments in all regions, and a calculation formula is:
$$max {f}_{1} = {\sum }_{i = 1}^{I} {\sum }_{j = 1}^{J} ( {\sum }_{k = 1}^{K} {x}_{j , k}^{i} - {d}_{j}^{i} ) {α}_{j} , \qquad ( 1 )$$
wherein dⱼⁱ is a water demand of a j-th water use department in an i-th region; x_{j,k}ⁱ is a water supply for a k-th water source to the j-th water use department in the i-th region; I, J and K are a total number of regions, a total number of water use departments and a total number of water sources respectively; αⱼ is a water supply order coefficient, that is, a water use order of the j-th water use department;
(2) objective function of maximum economic benefit
taking a water supply benefit max f₂ considering a water supply order as a maximum economic benefit goal of initial allocation of water rights, wherein a calculation formula is:
$$max {f}_{2} = {\sum }_{i = 1}^{I} {\sum }_{j = 1}^{J} {\sum }_{k = 1}^{K} ( {b}_{j}^{i} - {c}_{j , k}^{i} ) {x}_{j , k}^{i} {α}_{j} , \qquad ( 3 )$$
wherein bⱼⁱ is a water supply benefit coefficient of the j-th water use department in the i-th region; and c_{j,k}ⁱ is a cost coefficient of supplying water for the k-th water source to the j-th water use department in the i-th region;
(3) objective function of maximum ecological benefit
taking an ecological guarantee rate max f₃ as a maximum ecological benefit goal, wherein a calculation formula is:
$$max {f}_{3} = - {\sum }_{i = 1}^{I} {\sum }_{j = 1}^{J} \frac{{\sum }_{k = 1}^{K} {x}_{j , k}^{i}}{{P}_{j}^{i}} , \qquad ( 4 )$$
wherein Pⱼⁱ is an ecological water demand of the j-th water use department in the i-th region;
S3: constraint condition setting
constraint conditions comprise a supply and demand balance constraint of a water resource and a water demand constraint of a water use department:
(1) the supply and demand balance constraint of the water resource
$${\sum }_{i = 1}^{I} {\sum }_{j = 1}^{J} {\sum }_{k = 1}^{K} {x}_{j , k}^{i} \leq {\sum }_{k = 1}^{K} {W}_{k} , \qquad ( 5 )$$
wherein Wₖ is an available water supply of the k-th water source;
(2) the water demand constraint of the water use department
$${Q}_{min , j}^{i} \leq {d}_{j}^{i} \leq {Q}_{max , j}^{i} , \qquad ( 6 )$$
wherein Q_{min,j}ⁱ and Q_{max,j}ⁱ are a minimum water demand and a maximum water demand of a j-th water user in the i-th region, respectively;
S4: multi-objective optimization algorithm
using a second generation non-dominated sorting genetic algorithm for initial optimization allocation of water rights, and obtaining an optimal allocation amount of each water source to different regions and industries; and
S5: initial allocation schemes of water rights based on regret theory
performing normalization on Pareto frontiers obtained after optimization in the S4 to eliminate an influence of different dimensions on decision-making results;
then, from a perspective of an attribute k, performing quantification of regret values of selected schemes; and
finally, comparing and selecting different schemes by a regret metric function, taking a minimum regret metric function as a best scheme.

2. The initial allocation optimization method of water rights based on regret theory according to claim 1, wherein:
a formula for calculating the water use order αⱼ of the j-th water use department in the S2 is:
$${α}_{j} = \frac{1 + {n}_{max} - {n}_{j}}{{\sum }_{j = 1}^{J} {n}_{j}} , \qquad ( 2 )$$
wherein nⱼ is a water use order; nₘₐₓ is a maximum value of the water use order.

3. The initial allocation optimization method of water rights based on regret theory according to claim 2, wherein:
steps of the initial optimization allocation of water rights in the S4 are as follows:
step 1: randomly initializing a parent population P₀ with a scale of n, ranking all individuals according to a non-dominant relationship and specifying a fitness value, and using selection, crossover and mutation operators to generate a next generation population Q₀ with a scale of n, and letting t=1;
step 2: judging whether a termination condition has been reached or whether evolutionary algebra t has reached a maximum; if the termination condition has been reached or the evolutionary algebra t has reached the maximum, terminating an evolution and outputting a current quasi-Pareto frontier; if the termination condition has not been reached or the evolutionary algebra t has not reached the maximum, continuing;
step 3: merging a parent Pₜ and a child Qₜ into a population Rₜ with 2n individuals;
step 4: performing non-dominated sorting and congestion comparison on the population Rₜ after the merging to generate a new population Pₜ₊₁ with a scale of n;
step 5: for a new generation population, repeating a next round of selection, crossover and mutation to obtain a new child Qₜ₊₁; and
step 6: when the evolutionary algebra t=t+1, turning back to the step 2.

4. The initial allocation optimization method of water rights based on regret theory according to claim 3, wherein:
the normalization in the S5 is performed by a following formula:
$${z}_{i}^{k} = \frac{{y}_{i}^{k} - {y}_{i , min}^{k}}{{y}_{i , max}^{k} - {y}_{i , min}^{k}} , \qquad ( 7 )$$
wherein yᵢ^{k} represents a performance value of a scheme i (i=1, 2, . . . I) on the attribute k (k=1, 2, 3); y_{i,max}^{k} and y_{i,min}^{k} are a maximum value and a minimum value of yᵢ^{k} respectively; zᵢ^{k} represents a performance value of the scheme i (i=1, 2, . . . I) after the normalization on the attribute k (k=1, 2, 3).

5. The initial allocation optimization method of water rights based on regret theory according to claim 4, wherein:
the quantification of the regret values in the S5 is performed by a following formula:
$${R}_{i ↔ j}^{k} = ln ( γ + exp [ {β}_{k} ( {z}_{j}^{\dot{k}} - {z}_{i}^{k} ) ] ) , \qquad ( 8 )$$
wherein zᵢ^{k} and zⱼ^{k} are performance values after the normalization of the scheme i and a scheme j corresponding to the attribute k, respectively; βₖ is a preference parameter, indicating a contribution of the attribute k to a total regret; and γ is a regret weight parameter, indicating an intensity of regret.

6. The initial allocation optimization method of water rights based on regret theory according to claim 5, wherein:
the regret metric function in the S5 is expressed by a following formula:
$${R}_{i} = {\sum }_{j = 1 , j \neq i}^{J} {\sum }_{k = 1}^{3} ln ( γ + exp [ {β}_{k} ( {z}_{j}^{k} - {z}_{i}^{k} ) ] ) . \qquad ( 9 )$$

7. The initial allocation optimization method of water rights based on regret theory according to claim 6, wherein:
a value range of the preference parameter βₖ is [0,1], and a sum of the preference parameters is 1; and
a value range of the regret weight parameter is [0,1].
